(19) United States
(12) Patent Application Publication
(10) Pub. No.: US 2006/0073838 A1
(43) Pub. Date: Apr. 6, 2006

(54) Automatic critical health care service system using wireless communication, positioning and/or RF ID

(76) Inventors: Tayeb A. Kamali, Abu Dhabi (AE); Hamad Odhabi, Abu Dhabi (AE); Senthil Nathan, Abu Dhabi (AE); Ramachandran Anand Kumar, Abu Dhabi (AE)

Correspondence Address: Abu Dhabi Men's College;Higher Colleges of Technology,, Al Saada Street, P.O. Box 25035, Abu Dhabi, AE

(21) Appl. No.: 10/937,368

(22) Filed: Sep. 10, 2004

(51) Int. Cl. H04Q 7/20

(52) U.S. Cl. 455/456.1

(57) ABSTRACT

Three solutions for an automatic critical health care service system are proposed. First two solutions include a mobile phone device, a service provider system, a home hospital system and a nearest hospital system. The third solution also includes a RF ID technology based storage means. The mobile phone device comprises location measurement means, storage means, tagging means, wireless ground communication means and wireless satellite communication means; solution 3 includes RF ID reader means. The service provider system comprises storage means, wireless ground communication means, wireless satellite communication means, wired communication means, tagging means and Geographic and Health Data Retrieval Means (in solution 2 and 3 this is Geographic Data Retrieval Means). The home hospital system comprises mobile receiver means and storage means (storage only in solution 1). The nearest hospital system comprises mobile receiver means, email receiver means and fax receiver means (fax only in solution 1).

### CROSS REFERENCE TO RELATED APPLICATIONS

Not Applicable

### COPYRIGHT STATEMENT

Not Applicable

### FEDERAL RESEARCH STATEMENT

Not Applicable

### APPENDIX DATA

Other References

[1] U.S. Pat. No. 6,574,484 “Method for emergency service access using a mobile phone”
[2] U.S. Pat. No. 6,262,666 “Method of and apparatus for individuals to maintain a trail of their well being and whereabouts”
[3] http://www.nokia.com/nokia/0,8764,48663,00.html (GPS)
[4] http://www.nokia.com/nokia/0,55738,00.html (RF ID)
[5] Performance and reliability of Radio Frequency Identification (RFID), Master's Thesis in Information and Communication Technology, Hussain Al-Mousawi, Agder University College, Norway, 2004.

### BACKGROUND OF INVENTION

A patient may have critical health condition that does not require hospitalization but may, at short notice, require quick medical attention. Today such a patient can call his/her own hospital/doctor when needed from a wired or wireless phone. The patient would still need to talk to the hospital representative to indicate current location and may need to provide reference to his/her own hospital for medical history and records. One solution is voluntary tracking of patient's location and/or well being [2]. An alternate solution is to use an emergency service number from a mobile number [1].

Nokia has provided capability to integrate GPS [4] and RF ID [5] technologies into its mobile phones.

RF ID technology has been used for transportation, personnel access, animals, industrial and business applications; this technology has also been used for toll collection, access control and a wide variety of applications in commerce [5]. Recently, RF ID technology has been used in e-Plates project [2]: active (battery powered) RF ID tags are embedded in the license plates to identify vehicles in real time. This has enabled reliable identification of any vehicle, anywhere, whether stationary or mobile, and in all weather conditions.

### SUMMARY OF INVENTION

Patients may critical conditions like diabetes or low blood sugar that may require, at short notice, quick medical attention. This invention provides three solutions to this problem. In all solutions, the patient dials an emergency number such as 911 [send] from a locked or unlocked mobile phone. The mobile phone compares the entered value (911) with a list of known emergency numbers stored in the memory (e.g., SIM card) of the mobile phone. If the entered number is on the known emergency number list, the mobile phone sends message (e.g., Short Message Service message) to the service provider with the current location of patient. On being intimated, the nearest hospital to patient's current location would send an ambulance and medical team to the patient.

In the first solution, the service provider determines the hospital nearest to the patient's current location. The service provider also automatically retrieves the patient's critical health records and informs the nearest hospital through a message, fax and/or email. The patient's home doctor is also informed of the emergency condition.

In the second solution, the service provider determines the hospital nearest to the patient's current location and the information is sent back to the patient's mobile telephone as a message. The mobile phone, automatically, retrieves the patient's critical health records from its memory and informs the nearest hospital to patient's current location and the patient's home doctor through messaging.

In the third solution, the service provider determines the hospital nearest to the patient's current location and the information is sent back to the patient's mobile receiver as a message. The mobile phone, automatically, retrieves the patient's critical health records from it's the RF ID tag using the RF ID reader and informs the nearest hospital to patient's current location and the patient's home doctor through messaging.

There are a number of position determination techniques (e.g., Global Positioning System—GPS, Ericsson's network based Mobile Positioning System) that can be used.

### BRIEF DESCRIPTION OF DRAWINGS

FIG. 1 illustrates a schematic view of a preferred implementation solution 1 of the system.

FIG. 2 illustrates a schematic view of a preferred implementation solution 2 of the system.

FIG. 3 illustrates a schematic view of a preferred implementation solution 1 of the system.

### BRIEF DESCRIPTION OF SEQUENCES

Not Applicable

### DETAILED DESCRIPTION

This invention is applicable to various types of mobile phones including but not restricted to ground based (e.g., GSM, 3G) mobile phones, satellite based mobile phones and Personal Digital Assistant (PDA) based mobile phones.

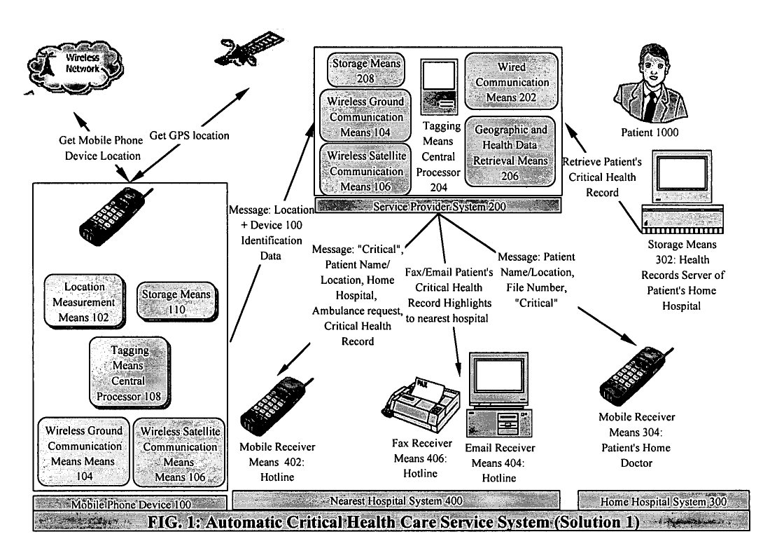

Referring now to FIG. 1, there is illustrated solution 1 of a system for providing critical health care service. The system includes a mobile phone device which is represented by the numeral 100.

Device 100 comprises a location measurement means 102 that determines the location of device 100 and thereby the Patient 1000. The location measurement means 102 determines the GPS location of device 100 and thereby the patient 1000 using Wireless Satellite Communication means 106; alternatively, the location measurement means 102 can determine the location of device 100 and patient 1000 using Wireless Ground Communication means 104 (e.g., Ericsson's Mobile Positioning System with GSM or 3G). The signal indicative of the location measurement can be converted to alphanumeric data.

Device 100 comprises Wireless Satellite Communication Means 106 and/or Wireless Ground Communication Means 104. Wireless Satellite Communication Means 106 can communicate via satellite to get GPS location and send a message with location data and device 100 identification data using messaging (e.g., SMS). The location data can always be sent via satellite or where ground wireless communication network is not available. Wireless Ground Communication Means 104 can communicate via ground wireless network (e.g., GSM or 3G) to get location data (e.g., using Ericsson's network based Mobile Positioning System) and send location data and device 100 identification data using messaging (e.g., SMS). Wireless Ground Communication Means 104 will be used to determine location of device 100 and patient 1000 if the wireless network provides this capability.

Device 100 comprises a means, such as the central processor 108 for tagging the alphanumeric device 100 identification data (e.g., mobile phone device 100 number) with the signal indicative of the location measurement of device 100 and patient 1000. The mobile phone device identification data and location of patient 1000 could all be alphanumeric in nature. Device 100 identification data and location data is sent immediately to service provider system 200.

Device 100 comprises a storage means (this could be the SIM card or some other means) to store the allowed emergency numbers, the service provider system 200 messaging number and the device 100 identification data.

Service Provider System 200 comprises of Wireless Ground Communication Means 104 and/or Wireless Satellite Communication Means 106 to automatically communicate with devices 100, 102 and 304 through messages. The means 104 and 106 are well known in the art. Service Provider System 200 receives location data and mobile phone device identification data from device 100. Service provider System 200 sends patient critical health data (this includes but is not limited to patient name/location, patient's home hospital, ambulance request and patient's critical health record) to device 402 (this mobile phone device is well known in the art). Service provider also sends data (this includes but is not limited to patient name/location, file number and level of criticality) to the patient's home doctor via device 304 (this mobile phone device is well known in the art).

Service Provider System 200 comprises a Wired Communication Means 202 to automatically communicate with Storage Means 302 to retrieve patient's critical health record from the patient's home hospital system 300 based on mobile phone device 100 identification data. Service Provider System 200 sends a fax and/or email with the patient's critical health record to the fax receiver means 406 and email receiver means 404 in the hospital nearest 400 to the patient 1000 current location. The Wired Communication means 202 may also be used to retrieve geographic data. The means 202 are well known in the art.

Service Provider System 200 comprises a central processor 204 for tagging means to tag the message for the patient's home doctor in the home hospital system 300 with his contact details. The tagging means also tags the critical health record for the nearest hospital system 400 with the contact addresses of mobile receiving means and/or fax receiver means and/or email receiver means of the nearest hospital system in claim 400.

Service provider System 200 comprises a Geographic and Health Data Retrieval Means 206. The geographic data pertains to the fax, email and messaging numbers for the hospital system geographically nearest 400 to the patient 1000 current location (this could be retrieved, for example, from a Geographical Information System—GIS for hospitals in the city of patient's current location). The geographical data is automatically retrieved. The Geographical and Health Data Retrieval Means is also used by the Service Provider System 200 to retrieve patient 1000 critical health data (this includes but is not limited to patient name, home hospital, home doctor, home doctor contact number, file number, critical medical information, drug allergies, temporary conditions like pregnancy) from storage means 302 in home hospital system 300.

Service Provider System 200 also comprises a storage means 208 to store location data of hospital, and contact addresses of mobile receiver means 304, fax receiver means 406 and email receiver means 404 of nearest hospital system 400.

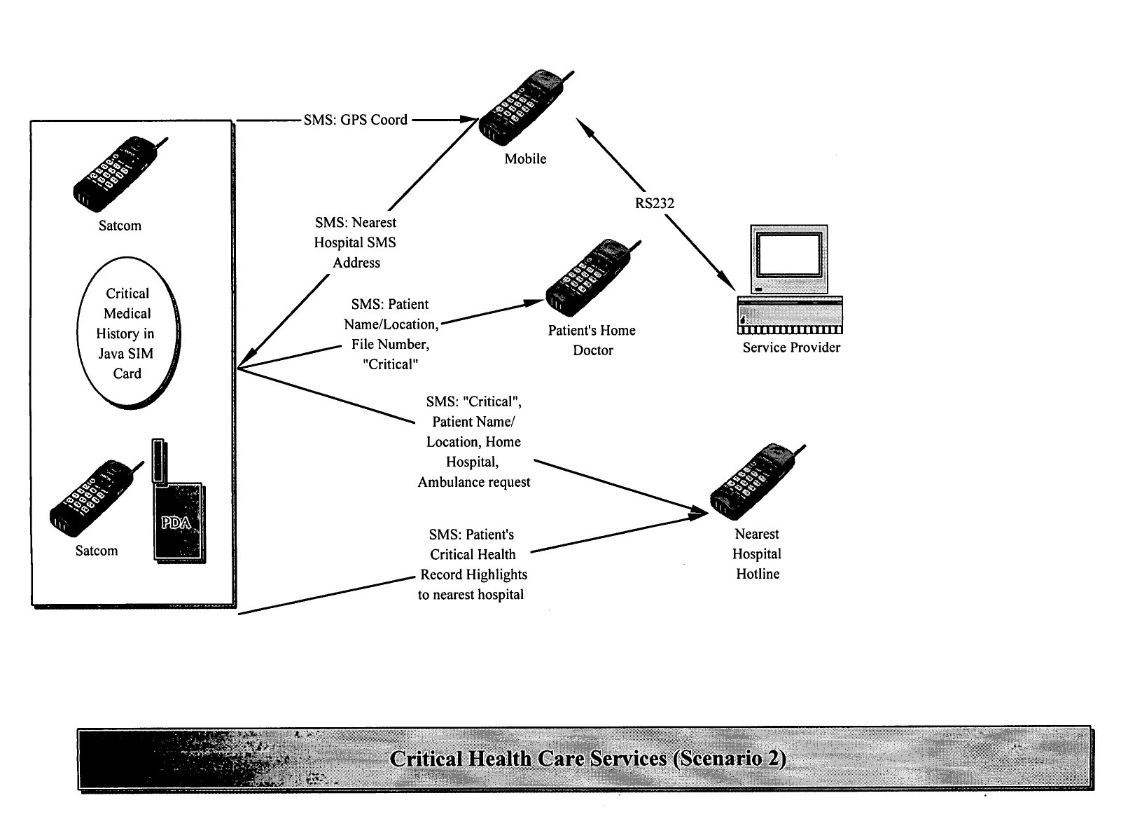

Referring now to FIG. 2, there is illustrated solution 2 of a system for providing critical health care service. Here we will describe the differences with FIG. 1. The main difference is that the patient 1000 critical health record is stored in the mobile phone device itself.

Mobile phone device 500 differs from mobile phone device 100 in that it comprises storage means 510 which differs from storage means 110. Storage means 510 stores the allowed emergency numbers, the service provider 600 messaging number and the mobile phone device 500 identification data as does the storage means 110. In addition it also stores the critical health record (this includes but is not limited to patient name, home hospital, home doctor, home doctor contact number, file number, critical medical information, drug allergies, temporary conditions like pregnancy) of patient 1000. An example of such a storage means is a Java or Smart SIM card. The central processor 108 could be the processor on such a Java/Smart SIM card. The mobile phone device 100 comprises a tagging means 508 (this differs from tagging means 108 in FIG. 1) for tagging the alphanumeric mobile phone device 500 identification data with the signal indicative of the location measurement of said mobile phone device and patient 1000. This tagging means tags the message for the patient's home doctor in the home hospital system 700 with his contact details. The tagging means also tags the critical health record for the nearest hospital system 800 with the hotline mobile receiver means 402 and/or email receiver means 404 of the nearest hospital system 800.

Service Provider System 600 differs from Service Provider System 200 in that Geographic and Health Data Retrieval Means 206 is replaced with Geographic Data Retrieval Means 606. The latter only retrieves geographic data that is sent to mobile phone device 500 and patient 1000.

The Service Provider System 600 comprises a storage means 608 (this differs from storage means 208 in FIG. 1) that stores location data of hospital, and contact addresses of mobile receiver means and email receiver means of nearest hospital system in claim 9;

The Service Provider Systems comprises a tagging means 604 (this differs from tagging means 204 in FIG. 1) to tag identification data of the mobile phone device 500 to the contact address of hotline mobile receiver means 402 and/or email receiver means 404 of the nearest hospital system 800.

Furthermore, Mobile Phone Device 500 communicates directly with mobile phone device 402 and email receiver means 404 in the nearest hospital system 800. There is no fax message sent. The mobile phone device 500 also communicates directly with mobile phone device 304 of the patient's home doctor in the home hospital system 700. There is no need to retrieve the patient's critical health record from the home hospital system 700.

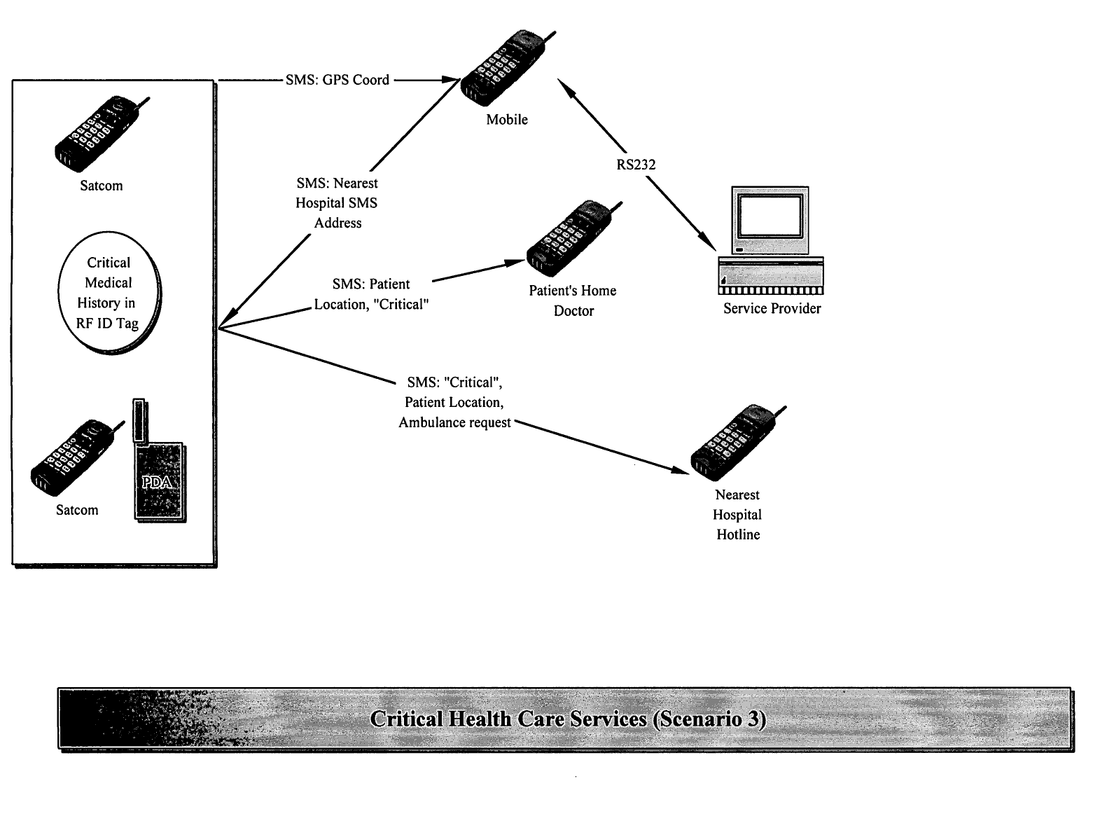

Referring now to FIG. 3, there is illustrated solution 3 of a system for providing critical health care service. Here we will describe the differences with FIG. 2. The main difference is that the patient 1000 critical health record is stored in a RD ID tag 1002 that is located on the patient 1000.

Mobile phone device 900 differs from mobile phone device 100 in that it comprises storage means 110 as in mobile phone device 100 in FIG. 1. Storage means 110 in FIG. 3 stores the allowed emergency numbers, the service provider 600 messaging number and the mobile phone device 900 identification data. The critical health record (this includes but is not limited to patient name, home hospital, home doctor, home doctor contact number, file number, critical medical information, drug allergies, temporary conditions like pregnancy) of patient 1000 is stored in the RF ID tag 1002 on patient 1000. The RF ID reader means 912 automatically reads the critical health record from the RF ID tag 1002 when the appropriate emergency number (e.g., 911) is dialed.

Program Listing Deposit

[Beginning of Program]
[Insert program here]
[End of Program]
   Not Applicable

What we claim is:

1. An automatic critical health care service system comprising
a mobile phone device
a service provider system
a home hospital system
a nearest hospital system

2. The mobile phone device is claim 1 comprising
a location measurement means to determine the location of the said mobile phone device and the patient;
a storage means to store the allowed emergency numbers, the service provider messaging number and the mobile phone device identification data;
tagging means for tagging the alphanumeric mobile phone device identification data with the signal indicative of the location measurement of said mobile phone device and patient;
a wireless satellite communication means and/or wireless ground communication means for obtaining location data from satellite or ground wireless network and to communicate with service provider system.

3. The service provider system of claim 1 comprising
a wireless satellite communication means and/or wireless ground communication means and/or wired communication means to communicate with service provider mobile phone device of patient in claim 2, home hospital system in claim 4 and nearest hospital system in claim 5;
a storage means to store location data of hospital, and contact addresses of hotline mobile receiver means, fax receiver means and email receiver means of nearest hospital system in claim 5;
a geographic and health data retrieval means to retrieve location and contact details of hospital nearest to patient's current location. This means also retrieves the critical health record of the patient from the storage means of patient's home hospital system in claim 4;
a tagging means to tag the message for the patient's home doctor in the home hospital system (in claim 4) with his contact details. The tagging means also tags the critical health record for the nearest hospital system in claim 5 with the contact addresses of mobile receiving means and/or fax receiver means and/or email receiver means of the nearest hospital system in claim 5.

4. The home hospital system of claim 1 comprising
a storage means to store the health records (including critical health record and patient's doctor contact details) of patients associated with the hospital;
a mobile receiver means for doctor of patient to receive critical health record message from Service Provider System in claim 2. The mobile receiver means can be one of the following types: receive from a satellite or receive from ground based wireless network.

5. The nearest home hospital system of claim 1 comprising
a mobile receiver means which serves as hospital's hotline to receive critical health record message from Service Provider System in claim 2. The mobile receiver means can be one of the following types: receive from a satellite or receive from ground based wireless network;
a fax receiver means which serves as hospital's hotline to receive critical health record message from Service Provider System in claim 2;
an email receiver means which serves as hospital's hotline to receive critical health record message from Service Provider System in claim 2.

6. The mobile phone device is claim 1 comprising
a location measurement means to determine the location of the said mobile phone device and the patient;
a storage means to store the allowed emergency numbers, the service provider messaging number and the mobile phone device identification data. This storage means also stores the critical health record of the patient along with the contact details of the mobile receiver means of patient's doctor in home hospital of claim 8;
a tagging means for tagging the alphanumeric mobile phone device identification data with the signal indicative of the location measurement of said mobile phone device and patient. This tagging means tags the message for the patient's home doctor in the home hospital system (in claim 8) with his contact details. The tagging means also tags the critical health record for the nearest hospital with the hotline mobile phone device and/or email receiver means of the nearest hospital system in claim 9.
a wireless satellite communication means and/or wireless ground communication means for obtaining location data from satellite or ground wireless network and to communicate with service provider system in claim 7.

7. The service provider system of claim 1 comprising
a wireless satellite communication means and/or wireless ground communication means and/or wired communication means to communicate with service provider mobile phone device of patient in claim 6, home hospital system in claim 8 and nearest hospital system in claim 9;
a storage means to store location data of hospital, and contact addresses of mobile receiver means and email receiver means of nearest hospital system in claim 9;
a geographic data retrieval means to retrieve location and contact details of hospital nearest (in claim 9) to patient's current location;
a tagging means to tag identification data of the mobile phone device in claim 6 to the contact address of hotline mobile receiver means and/or email receiver means of the nearest hospital system in claim 9.

8. The home hospital system of claim 1 comprising
a mobile receiver means for doctor of patient to receive critical health record message from Mobile Phone Device in claim 6. The mobile receiver means can be one of the following types: receive from a satellite or receive from ground based wireless network.

9. The nearest home hospital system of claim 1 comprising
a mobile receiver means which serves as hospital's hotline to receive critical health record message from Mobile Phone Device in claim 6. The mobile receiver means can be one of the following types: receive from a satellite or receive from ground based wireless network;
an email receiver means which serves as said hospital's hotline to receive critical health record message from Mobile Phone Device in claim 6.

10. An automatic critical health care service system comprising
a mobile phone device;
a service provider system;
a home hospital system;
a nearest hospital system;
a RF ID technology storage means that is located on the patient to store the critical health record of the patient along with the contact details of the mobile receiver means of patient's doctor in home hospital of claim 13.

11. The mobile phone device is claim 10 comprising
a location measurement means to determine the location of the said mobile phone device and the patient;
a storage means to store the allowed emergency numbers, the service provider messaging number and the mobile phone device identification data;
a tagging means for tagging the alphanumeric mobile phone device (in claim 10) identification data with the signal indicative of the location measurement of said mobile phone device and patient. This tagging means tags the message for the patient's home doctor in the home hospital system (in claim 13) with his contact details. The tagging means also tags the critical health record for the nearest hospital with the hotline mobile receiver means and/or email receiver means of the nearest hospital system in claim 14.
a wireless satellite communication means and/or wireless ground communication means for obtaining location data from satellite or ground wireless network and to communicate with service provider system in claim 12;
an RF ID technology reading means to read, from the storage means of claim 10, the critical health record of the patient along with the contact details of the mobile receiver means of patient's doctor in home hospital of claim 13.

12. The service provider system of claim 10 comprising
a wireless satellite communication means and/or wireless ground communication means and/or wired communication means to communicate with mobile phone device of patient in claim 11, home hospital system in claim 13 and nearest hospital system in claim 14;
a storage means to store location data of hospital, and contact addresses of mobile receiver means, fax receiver means and email receiver means of nearest hospital system in claim 14;
a geographic data retrieval means to retrieve location and contact details of hospital nearest (in claim 14) to patient's current location;
a tagging means to tag the message for the patient's home doctor in the home hospital system (in claim 13) with his contact details. The tagging means also tags the critical health record for the nearest hospital system in claim 14 with the contact address of mobile phone device and/or fax receiver means and/or email receiver means of the nearest hospital system in claim 14.

13. The home hospital system of claim 10 comprising
a mobile receiver means for doctor of patient to receive critical health record message from Mobile Phone Device in claim 11. The mobile receiver means can be one of the following types: receive from a satellite or receive from ground based wireless network.

14. The nearest home hospital system of claim 10 comprising
a mobile receiver means which serves as hospital's hotline to receive critical health record message from Mobile Phone Device in claim 11. The mobile receiver means can be one of the following types: receive from a satellite or receive from ground based wireless network;
an email receiver means which serves as said hospital's hotline to receive critical health record message from Mobile Phone Device in claim 11.
